(19) United States
(12) Patent Application Publication
(10) Pub. No.: US 2002/0178095 A1
(43) Pub. Date: Nov. 28, 2002

(54) Method for accessing the business value of information technology

(76) Inventors: David P. Vellante, Still River, MA (US); Edward A. Gershenson, Sudbury, MA (US); David A. Floyer, Mountain View, CA (US); Leonard F. Swec, Danville, CA (US)

Correspondence Address: Gerald L. Smith, Mueller and Smith, LPA, 7700 Rivers Edge Drive, Columbus, OH, 43235, US

(21) Appl. No.: 10/053,304

(22) Filed: Nov. 7, 2001

Related U.S. Application Data
(60) Provisional application No. 60/246,741, filed on Nov. 8, 2000.

(51) Int. Cl. G06F 17/60

(52) U.S. Cl. 705/30

(57) ABSTRACT

A method for determining the net value of an information technology application or portfolio of applications. User value contributions for the application are developed by calculating internal user costs and external costs, following which, breakouts of the organizational IT budget as well as staffing costs and resources are carried out. From the data thus developed, total application value is determined in conjunction with an uplift factor as applied to a base application value. Factors representing unavailability, potential total loss, and inflexibility are derived and subtracted from the total application value along with a subtraction of a total IT budget to achieve a net application value corresponding with the value of the analyzed application.

### CROSS-REFERENCE TO RELATED APPLICATIONS

This application claims benefit of U. S. Provisional Application No. 60/246,741 filed Nov. 8, 2000.

### STATEMENT REGARDING FEDERALLY SPONSORED RESEARCH

Not applicable.

### BACKGROUND OF THE INVENTION

The genesis of the phenomena referred to in the business community as Information Technology (IT) is perhaps the development of the mainframe computer for the wartime task of computing shell trajectories. That vacuum tube implemented technology entered commerce during the 1950s. Usually housed in a climate controlled dedicated facility, these mainframe computers typically operated with Hollerith card implemented batch processing to evolve a computed output on magnetic tape or disk. Computer to computer connections appeared in the 1960s as part of preparation for surviving nuclear war. That communication system now is referred to as the “internet.” In effect, the internet is a multitude of networks which interconnect to transfer information but without the supervision of an oversight organization.

While personal computers were available before 1981, this was the year that IBM Corporation unveiled its PC, a product which readily was received by the business community. Over the years to follow, these desktop computers became more powerful as a multitude of software companies evolved programs, and solid state hardware improved remarkably. In 1989, a physicist at the European Particle Physics Laboratory, known as CERN proposed a worldwide web (WWW), a set of protocols layered upon the internet which utilized Hypertext, a technique for presenting and relating information which uses links rather than linear sequences. The Web was demonstrated in 1991 and expanded rapidly with hypermedia and multimedia software. Developed in concert with the Web were a series of software interface programs structured to aid in navigating the Web which are called “browsers.” In this regard, a team of programmers at the national center for superconducting applications (NCSA) developed a non-proprietary graphical interface browser for the Web which was released in 1993 under the name “Mosaic.” Within six months of that release, more than two million people downloaded Mosaic from the NCSA host computer in Champaign, Illinois. The Mosaic browser is a cross-platform application, such that it is able to run in various, different computing environments. The potential for profit-making business use of the internet commenced in the early 1990s when the National Science Foundation eliminated its support thereof. With this change, business began to use the internet, and the internet began a period of exponential growth.

This technological era also brought forth the database, a technology which includes software programs for creating and managing databases; the data itself which must be created or converted into storable form; and high capacity magnetic systems such as disk drives capable of storing enormous quantities of binary data.

A still third component of this technological era evolved Information Technology was the addition of communication networks. Mainframe computers fell into disfavor to be replaced by desktop computers performing with servers within both intranet and internet systems. More recently wireless communication has joined these technologies to further expand their growth.

Information Technology now permeates every aspect of a business, requiring chief executive officers (CEOs) to involve themselves in IT planning and decision making. Further, a new high level executive position, that of chief information officer (CIO), evolved in major institutions.

In the 1990s, IT has become the fourth major resource available to executives to shape and operate an organization. Companies have managed the other three major resources for years; people, money, and machines. But today IT accounts for more than 50% of the capital-goods dollars spent in the United States. It is time to see IT for what it is: a major resource that—unlike single-purpose machines such as lathes, typewriters, and automobiles—can radically affect the structure of the organization, the way it serves customers, and the way it communicates both internally and externally.

Understanding the importance of the fourth resource and building it into theory of the business (as well as into strategies and plans) are more important today than ever for the CEO. “The End of Delegation?” “Information Technology and the CEO”, Perspectives from the Editors, Harvard Business Review, Sept-Oct 1995.

The implantation and high capital investment of IT within business structures has called for a concomitant capability for evaluating its worth to an organization in consistent and understandable metrics. Traditional accounting-based technologies heretofore used by business and promoted in business schools generally fail to establish a workable gauge of the value of Information Technology. A wide range of these conventional methodologies have been employed to evaluate initially installed equipment and associated software. For example, one such method, referred to as “Total Cost of Ownership” (TCO) which sums all the different elements of any alternative philosophies or alternate ways of doing things has been employed. While these methods, as well as standard analyses involving return or investment (ROI) and time to breakeven, were applied to initial IT procurement, they generally fail where high level changes or IT variations are contemplated. Evaluating the business impact or dynamics of additions or improvements to initially installed legacy IT systems has been an illusive goal for business analysis, posing the dilemma of at least partially hunch-based procurement decisions on management.

As we shall see, computing a monetary value for a return from IT investments is not easy. In fact, in some cases, it almost appears impossible, at least at the time the firm is making the investment.

A good example is investing in IT infrastructure; a company might invest heavily to build a network of computers; the return from that network comes in literally hundreds of ways, as individual employees use the network to do their jobs better and IT staff members build applications of technology that take advantage of the network infrastructure. At the time the firm decided to invest in the network, it could only guess at the nature of activities the network might stimulate. A few years later, it is possible to study the return on the projects the network enabled, but it is a rare company that would devote the time and resources to such a post hoc analysis.

In searching for IT value, we seek all types of contributions from investments in technology. Some investments demonstrate traditional returns that can be expressed in monetary terms. Other examples demonstrate indirect returns from IT investments. Sometimes, it appears that an IT investment has prevented a negative return, for example, when a firm develops a system to keep up with a competitor and avoid losing market share. In instances where technology becomes intertwined with the strategy of the corporation, the contribution of IT seems very valuable but exceedingly difficult to value.

Lucas, Jr., H. C. “Information Technology and the Productivity Paradox”, pp 4-5, Oxford University Press, 1999.

With a view toward avoiding these past difficulties, a new method and system has been developed for assessing and quantifying the business value of an information technology application or set of such applications. See in this regard, U.S. patent Ser. No. 09/845,539 by David P. Vellante, et al., entitled “Method and System for Assessing and Quantifying the Business Value of an Information Technology (IT) Application or Set of Applications” filed Apr. 30, 2001 and assigned in common herewith. The first step of the method involves the calculation of a base application value based solely on the number of and cost associated with users of that application. As a next step, an actual application value is derived, wherein the base application value is adjusted by a coefficient evolved from business experience. As a final step, a potential business value is derived from which corresponding operational cost is removed. Using these values, a net business application value may be calculated. This methodology also may be applied to a set of business applications. The system of the invention involves components for inputting, processing, storing, and displaying data derived from application of the above-described method.

Despite this advance in IT application valuation, more advanced, detailed and accurate methods for valuation continue to be sought.

### BRIEF SUMMARY OF THE INVENTION

The present invention is addressed to a method for assessing and quantifying the value of an information technology (IT) application or set of such applications. With the assessment approach of the invention, analysts or senior management may efficiently derive net application values for one or a portfolio of applications in conjunction with a broad variety of informative metrics. The latter aspect of the methodology permits the generation of a broadened variety of analytic reports for a presentation to managerial decision-making authority.

With the method, the organization management is provided a compilation of pre-established input fields designed to accommodate prevalent business records and budget-keeping practices. The resultant data then is treated initially to derive a user value contribution both internal and external or outsourced active concurrent users of the application or portfolio being identified.

A breakout of the information technology budget is carried out in conjunction with an assigned number of cost categories including fully loaded staff cost (FLSC), hardware cost, software cost, network cost, consulting cost and other or miscellaneous cost. These budget splits initially are segregated as internal splits and outsourced splits and then combined to provide a sequence of total budget cost categories.

In addition to the noted budget breakout, a breakout of staffing costs and resources is carried out. This breakout is developed in conjunction with a number of staff function costs. Those functions comprise: senior management staff, new development staff, maintenance development staff, operations staff, technical staff, and other staff. Initially, the gross cost associated with each of these staff functions are determined both with respect to the internal staff and outsourced or external staff or personnel. To achieve a normalization of cost associated with these functions, the gross cost for both internal staff and outsourced staff are summarized and then percentages by cost for each of the functions both internal and outsourced are computed utilizing the summarized gross cost for internal and outsourced staff. Then normalization of cost by these functions made available by multiplying, for each function, the percentage cost times the fully loaded cost of staff. Those normalized staff function costs then are summarized, combining internal staff and outsourced staff values.

For the analytical reports, the computed percents by cost also are employed to calculate fulltime equivalent staff for each of the noted functions as attributed to internal staff and, additionally, outsourced staff. Again for analysis, those internal staff and outsourced fulltime equivalent members are summed to provide a summarization of fulltime equivalent staff by function. Then, the methodology builds summary budget categories comprising a compiled hardware, software, and network costs, consultant and other costs; information technology staff cost; and the various cost are compiled to establish an IT budget which corresponds with that IT budget retrieved in the initial gathering of data.

Upon developing the above-discussed breakout data, a base uplift factor is derived which is utilized to, in turn, derive an uplift factor for each of the applications, which factors are normalized. Then, the potentially synergistic impact of one application upon another or others is assessed with derivation of a interdependency factor. The interdependency factor then is employed in deriving a base application value in conjunction with internal user cost. Total application value then is derived using that base application value, the noted application uplift, and its external user cost.

As a component of the initial data gathering activity, the organization is requested to assess an outage impact, i.e., the impact of a loss of an application. For this purpose, a hierarchical archival sequence of consequences to the staff is presented in conjunction with a number designation for each such level. The methodology then employs the organization elected level of the sequence to assign a factor or percentage evaluation for each level. Then, an unavailability value is computed as the noted total application value times one minus typical availability multiplied again by the elected impact factor.

Evaluation of potential total loss is developed in a somewhat similar fashion. In this regard, again during the initial acquisition of data from the organization, the organization is requested to evaluate a hierarchical sequence of daily impact conditions for potential total loss. For this purpose, a sequence listing is provided with a numeric designator for each level of the sequence of perceived potential loss and the methodology, as before, assigns a major impact factor for each level of the sequence listing.

Next, a similar approach is taken to an evaluation of any mitigation of a potential total loss. Again, during the initial data compilation procedures, the organization is called upon to assess a disaster recovery method by electing one of a hierarchical listing of recovery schemes. Each such listing is assigned a numerical designation and the method provides a factor for each level of the sequence, for example, in terms of a percentage of disaster recovery budget. Using the earlier derived summary budget for tools and the accessed budget percent, the disaster recovery cost can be computed with the data list developed, potential total loss is evaluated by the calculation of disaster recovery cost or loss further is developed.

The method also calculates inflexibility. Using the compiled data, net application value is derived by removing select valuations from the earlier computed total application value.

The invention, accordingly, comprises the method possessing the steps which are exemplified in the following detailed disclosure.

For a fuller understanding of the nature and objects of the invention, reference should be had to the following detailed description taken in connection with the accompanying drawings.

### BRIEF DESCRIPTION OF THE DRAWINGS

FIG. 1 is a generalized overview form of flow chart illustrating the method of the invention;

FIG. 2 is a flow chart illustrating the measurement of user value contribution at a higher level of detail;

FIG. 3 is a flow chart showing a breakout IT budget feature at a higher level of detail;

FIG. 4 is a flow chart showing a breakout staffing cost and resources feature of the method at an enhanced level of detail;

FIG. 5 is a flow chart describing the calculate total and net application value feature of the method at an enhanced level of detail;

FIG. 6 is a flow chart illustrating the calculate unavailability feature of FIG. 5 at an enhanced level of detail; and

FIG. 7 is a flow chart illustrating the calculate potential total loss feature of the flow chart of FIG. 5 at an enhanced level of detail.

### DETAILED DESCRIPTION OF THE INVENTION

In the discourse to follow, the methodology of the invention is described generally in context that it is employed as a service to be supplied to business clients. The method can be employed with any of a number of societal entities in addition to conventional business operations, for example, with respect to academia, non-profit entities, governmental entities and the like. Accordingly, the term “organization” is in an encompassing manner.

The IT systems of a given organization are involved with an information technology infrastructure. These IT infrastructures are somewhat evasive to define, inasmuch as they are historically concerned with advances in the subject technology associated with hardware, software, communications, support, and the like. In 1996 investigators classified responses to surveys on infrastructure into eight categories:

1. Communications Management

2. Applications Management

3. Data Management

4. Standards Management

5. Education Management

6. Services Management

7. Security

8. IT R&D

Additionally, five core infrastructure services have been identified:

1. Management of corporation-wide communication network services

2. Management of group-wide or firmwide messaging services

3. Recommending standards for at least one component of IT architecture (hardware, operating system data, communications, etc.)

4. Security and disaster planning and recovery

5. Technology advice and support services

The study at hand also listed eighteen other possible infrastructure services including the actual management of firmwide applications, databases, consulting services, EDI management, training, and the like. See: “Information Technology and the Productivity Paradox” (supra) pp 98, 99.

The methodology of the invention is software driven and ultimately results in the development of a broad variety of analytical reports for senior management. Additionally, the results from the methodology are directed to database storage for a variety of purposes including the development of modeling studies, observation of historical trends, and the like. The methodology, in general, is discussed in connection with a singular application. However, a variety of applications will typically be encountered in any given investigation ultimately leading to the development of total application values and net application values. Because the end product may vary depending upon the needs of a given client, a variety of model or exemplary reports are provided herein as an appendix. To aid in the methodological description, two tabulations are provided. In Table 1, all of the input fields that are used with the method and system are listed in conjunction with bounds or validation values which are associated with each input. In general, these inputs are supplied by the client. Accordingly, they are arranged and the methodology is designed to comfort with conventional accounting and business practices. Table 2 provides a compilation of all of the calculations or derivations that are involved with, where appropriate, commentaries or constraints involved with such calculations.

TABLE 1

| ROW NO. | INPUT FIELD | VALID VALUES |
|---|---|---|
| 1 | Number Internal Users | Positive Number |
| 2 | Percent Internal Active | Positive percent |
| | Concurrent | |
| 3 | Internal User Salary | Positive number |
| 4 | Number External Users | Positive number |
| 5 | Percent External Active | Positive percent |
| | Concurrent | |
| 6 | External User Salary | Positive number |
| 7 | App Specific Uplift | Positive number |
| 8 | Revenue | Positive number |
| 9 | Employees | Positive number |
| 10 | Average Salary | Positive number |
| 11 | Total IT Budget | Positive number |
| 12 | Percent IT Budget | Positive percent |
| | Outsourced | |
| 13 | % App of IT Budget | Positive percent. Must sum to |
| | | 100% over all applications in portfolio. |
| 14 | I% FLSC App | Positive percent. I% FLSC App, |
| | | I% HW App, I% SW App, I% Network |
| | | App, I% Consult App, I% Other App must |
| | | sum to 100% for each application in the |
| | | portfolio. |
| 15 | I% HW App | Positive percent. I% FLSC App, |
| | | I% HW App, I% SW App, I% Network |
| | | App, I% Consult App, I% Other App must |
| | | sum to 100% for each application in the |
| | | portfolio. |
| 16 | I% SW App | Positive percent. I% FLSC App, |
| | | I% HW App, I% SW App, I% Network |
| | | App, I% Consult App, I% Other App must |
| | | sum to 100% for each application in the |
| | | portfolio. |
| 17 | I% Network App | Positive percent. I% FLSC App, |
| | | I% HW App, I% SW App, I% Network |
| | | App, I% Consult App, I% Other App must |
| | | sum to 100% for each application in the |
| | | portfolio. |
| 18 | I% Consult App | Positive percent. I% FLSC App, |
| | | I% HW App, I% SW App, I% Network |
| | | App, I% Consult App, I% Other App must |
| | | sum to 100% for each application in the |
| | | portfolio. |
| 19 | I% Other App | Positive percent. I% FLSC App, |
| | | I% HW App, I% SW App, I% Network |
| | | App, I% Consult App, I% Other App must |
| | | sum to 100% for each application in the |
| | | portfolio. |
| 20 | O% FLSC App | Positive percent. O% FLSC App, |
| | | O% HW App, O% SW App, O% Network |
| | | App, O% Consult App, O% Other App |
| | | must sum to 100% for each application in |
| | | the portfolio. |
| 21 | O% HW App | Positive percent. O% FLSC App, |
| | | O% HW App, O% SW App, O% Network |
| | | App, O% Consult App, O% Other App |
| | | must sum to 100% for each application in |
| | | the portfolio. |
| 22 | O% SW App | Positive percent. O% FLSC App, |
| | | O% HW App, O% SW App, O% Network |
| | | App, O% Consult App, O% Other App |
| | | must sum to 100% for each application in |
| | | the portfolio. |
| 23 | O% Network App | Positive percent. O% FLSC App, |
| | | O% HW App, O% SW App, O% Network |
| | | App, O% Consult App, O% Other App |
| | | must sum to 100% for each application in |
| | | the portfolio. |
| 24 | O% Consult App | Positive percent. O% FLSC App, |
| | | O% HW App, O% SW App, O% Network |
| | | App, O% Consult App, O% Other App |
| | | must sum to 100% for each application in |
| | | the portfolio. |
| 25 | O% Other App | Positive percent. O% FLSC App, |
| | | O% HW App, O% SW App, O% Network |
| | | App, O% Consult App, O% Other App |
| | | must sum to 100% for each application in |
| | | the portfolio. |
| 26 | Average Salary Sr Mgr | Positive number |
| 27 | Average Salary New Dev | Positive number |
| 28 | Average Salary Maint Dev | Positive number |
| 29 | Average Salary Ops | Positive number |
| 30 | Average Salary Tech | Positive number |
| 31 | Average Salary Other Staff | Positive number |
| 32 | IT Staff Count Internal | Positive number |
| 33 | % Sr Mgr Internal | Positive percent. Percent SR Mgr |
| | | Internal, Percent New Dev Internal, |
| | | Percent Ops Internal, Percent Tech |
| | | Internal and Percent Other Internal must |
| | | sum to 100% for each application in the |
| | | portfolio. |
| 34 | % New Dev Internal | Positive percent. Percent SR Mgr |
| | | Internal, Percent New Dev Internal, |
| | | Percent Ops Internal, Percent Tech |
| | | Internal and Percent Other Internal must |
| | | sum to 100% for each application in the |
| | | portfolio. |
| 35 | % Maint Dev Internal | Positive percent. Percent SR Mgr |
| | | Internal, Percent New Dev Internal, |
| | | Percent Ops Internal, Percent Tech |
| | | Internal and Percent Other Internal must |
| | | sum to 100% for each application in the |
| | | portfolio. |
| 36 | % Ops Internal | Positive percent. Percent SR Mgr |
| | | Internal, Percent New Dev Internal, |
| | | Percent Ops Internal, Percent Tech |
| | | Internal and Percent Other Internal must |
| | | sum to 100% for each application in the |
| | | portfolio. |
| 37 | % Tech Internal | Positive percent. Percent SR Mgr |
| | | Internal, Percent New Dev Internal, |
| | | Percent Ops Internal, Percent Tech |
| | | Internal and Percent Other Internal must |
| | | sum to 100% for each application in the |
| | | portfolio. |
| 38 | % Other Staff Internal | Positive percent. Percent SR Mgr |
| | | Internal, Percent New Dev Internal, |
| | | Percent Ops Internal, Percent Tech |
| | | Internal and Percent Other Internal must |
| | | sum to 100% for each application in the |
| | | portfolio. |
| 39 | IT Staff Count Outsourced | Positive number |
| 40 | % Sr Mgr Outsourced | Positive percent. Percent SR Mgr |
| | | Outsourced, Percent New Dev |
| | | Outsourced, Percent Ops Outsourced, |
| | | Percent Tech Outsourced and Percent |
| | | Other Outsourced must sum to 100% for |
| | | each application in the portfolio. |
| 41 | % New Dev Outsourced | Positive percent. Percent SR Mgr |
| | | Outsourced, Percent New Dev |
| | | Outsourced, Percent Ops Outsourced, |
| | | Percent Tech Outsourced and Percent |
| | | Other Outsourced must sum to 100% for |
| | | each application in the portfolio. |
| 42 | % Maint Dev Outsourced | Positive percent. Percent SR Mgr |
| | | Outsourced, Percent New Dev |
| | | Outsourced, Percent Ops Outsourced, |
| | | Percent Tech Outsourced and Percent |
| | | Other Outsourced must sum to 100% for |
| | | each application in the portfolio. |
| 43 | % Ops Outsourced | Positive percent. Percent SR Mgr |
| | | Outsourced, Percent New Dev |
| | | Outsourced, Percent Ops Outsourced, |
| | | Percent Tech Outsourced and Percent |
| | | Other Outsourced must sum to 100% for |
| | | each application in the portfolio. |
| 44 | % Tech Outsourced | Positive percent. Percent SR Mgr |
| | | Outsourced, Percent New Dev |
| | | Outsourced, Percent Ops Outsourced, |
| | | Percent Tech Outsourced and Percent |
| | | Other Outsourced must sum to 100% for |
| | | each application in the portfolio. |
| 45 | % Other Staff Outsourced | Positive percent. Percent SR Mgr |
| | | Outsourced, Percent New Dev |
| | | Outsourced, Percent Ops Outsourced, |
| | | Percent Tech Outsourced and Percent |
| | | Other Outsourced must sum to 100% for |
| | | each application in the portfolio. |
| 46 | % Allocateₙₘ | Positive Percent. n represents the |
| | | specific application in the portfolio. m |
| | | represents another application in the |
| | | portfolio. Percent must sum to 100% for |
| | | each application n. |
| 47 | Outage Impact | 1 = They do something else that’s |
| | | equally productive |
| | | 2 = They do something else |
| | | moderately productive |
| | | 3 = They do something else that’s |
| | | far less productive |
| | | 4 = They perform the same task |
| | | manually |
| | | 5 = They can do nothing. |
| | | Productivity is severely impacted. |
| | | 6 = It is a major exercise to |
| | | restore the systems when they return |
| 48 | Daily Impact | 1 = Department Impacted but |
| | | business Continues |
| | | 2 = Major dislocation to internal |
| | | departments |
| | | 3 = Significant impact on revenue |
| | | 4 = Severe impact on business |
| | | revenue |
| | | 5 = It’s a business disaster that |
| | | they read about it in the Wall Street |
| | | Journal. Company goodwill is severely |
| | | impaired. |
| 49 | Scheduled Hours | Positive number |
| 50 | Downtime | Positive number |
| 51 | DR Method | 1 = Daily, full backup |
| | | 2 = Daily incremental backup and |
| | | Weekly full backup |
| | | 3 = Weekly, full backup - no |
| | | incremental backup |
| | | 4 = Infrequent backup - mixture of |
| | | approaches |
| | | 5 = Other |

TABLE 2

| Row No. | Variable Name | Description | Calculation | Comments/Constraints |
|---|---|---|---|---|
| 1 | Internal user cost | The cost of full time | Number Internal Users * | |
| | | equivalent employees | Percent Internal Active | |
| | | (FTEs) who use an | Concurrent * Internal | |
| | | application full time. | User Salary | |
| 2 | External user cost | The cost of “avoided | Number External Users | |
| | | employees” by | * Percent External | |
| | | allowing customers to | Active Concurrent * | |
| | | access your | External User Salary | |
| | | applications | | |
| | | themselves. | | |
| 3 | Interdependency | The percent of an | Sum of | For each |
| | factor | application’s value that | (% Allocateₙ₁through | application |
| | | comes from synergies | % Allocateₙᵢ) | n, in the |
| | | with other | portfolio of | |
| | | applications. | application | |
| | | | | s from 1 to |
| | | | | i, where i is |
| | | | | the last |
| | | | | application |
| | | | | in the |
| | | | | portfolio |
| 4 | Base uplift | The average multiplier | Revenue / (Employees * | |
| | | of the company, or the | Average Salary) | |
| | | number of dollars you | | |
| | | earn for each you | | |
| | | spend on employees. | | |
| 5 | Application uplift | The multiplier | Application Specific | |
| | | associated with a | Uplift * Base Uplift / | |
| | | specific application, | (Sum of Application | |
| | | reflecting the relative | Specific Uplifts) | |
| | | value of the | | |
| | | application within the | | |
| | | portfolio. | | |
| 6 | Base application | The value of an | Internal User Cost * | |
| | value | application since the | Interdependency Factor | |
| | | application would not | | |
| | | have been built if it | | |
| | | were not worth the | | |
| | | cost of the people | | |
| | | using it. | | |
| 7 | Total application | Application Value with | Base Application Value | |
| | value | all uplifts and | * Application Uplift + | |
| | | interdependencies | External User Cost | |
| | | taken into account, | | |
| | | per application | | |
| 8 | Internal IT Budget | The portion of the IT | Total IT Budget * (1 - | |
| | | Budget used within | Percent IT Budget | |
| | | the company | Outsourced) | |
| 9 | Outsourced IT | The portion of the IT | Total IT Budget * | |
| | Budget | Budget paid to an | Percent IT Budget | |
| | | outsourcing company. | Outsourced | |
| 10 | Internal FLSC | Fully Loaded Staff | Percent App of IT | |
| | | Costs (salary, | Budget * I% FLSC App * | |
| | | benefits, etc.) for | Internal IT Budget | |
| | | internal staff. | | |
| 11 | Outsourced FLSC | Fully Loaded Staff | Percent App of IT | |
| | | Costs (salary, | Budget * O% FLSC App | |
| | | benefits, etc.) for | * Outsourced IT Budget | |
| | | outsourced staff. | | |
| 12 | FLS Cost | Total fully loaded staff | Internal FLSC + | |
| | | costs. | Outsourced FLSC | |
| 13 | Internal Hardware | The cost of hardware | % App of IT Budget * | |
| | Cost | (servers, computers, | I% HW App * Internal | |
| | | tapes, etc.) bought | Budget | |
| | | and maintained | | |
| | | internally. | | |
| 14 | Outsourced | The cost of hardware | % App of IT Budget * | |
| | Hardware Cost | (servers, computers, | O% HW App * | |
| | | tapes, etc.) bought | Outsourced IT Budget | |
| | | and maintained by the | | |
| | | outsourcer. | | |
| 15 | Hardware Cost | Total hardware cost. | Internal Hardware Cost + | |
| | | | Outsourced | |
| | | | Hardware Cost | |
| 16 | Internal Software | The cost of software | % App of IT Budget * | |
| | Cost | bought and maintained | I% SW App * Internal IT | |
| | | internally. | Budget | |
| 17 | Outsourced | The cost of software | % App of IT Budget | |
| | Software Cost | bought and maintained | O% SW App * | |
| | | by the outsourcer. | Outsourced IT Budget | |
| 18 | Software Cost | Total software costs. | Internal Software Cost + | |
| | | | Outsourced Software | |
| | | | Cost | |
| 19 | Internal Network | The cost of | % App of IT Budget * | |
| | Cost | networking (wiring, | I% Network App * | |
| | | routers, etc.) bought | Internal IT Budget | |
| | | and maintained | | |
| | | internally. | | |
| 20 | Outsourced | The cost of | % App of IT Budget * | |
| | Network Cost | networking bought | O% Network App * | |
| | | and maintained by the | Outsourced IT Budget | |
| | | outsourcer. | | |
| 21 | Network Cost | Total cost of | Internal Network Cost + | |
| | | networking. | Outsourced Network | |
| | | | Cost | |
| 22 | Internal Consult | The cost of | % App of IT Budget * | |
| | Cost | consultants who work | I% Consult App * | |
| | | daily internally at the | Internal IT Budget | |
| | | company. | | |
| 23 | Outsourced | The cost of | % App of IT Budget * | |
| | Consult Cost | consultants who work | O% Consult App * | |
| | | daily at the | Outsourced IT Budget | |
| | | outsourcer. | | |
| 24 | Consulting Cost | Total cost of | Internal Consult Cost + | |
| | | consultants. | Outsourced Consult | |
| | | | Cost | |
| 25 | Internal Other Cost | Miscellaneous internal | % App of IT Budget * | |
| | | IT costs. | I% Other App * Internal | |
| | | | IT Budget | |
| 26 | Outsourced Other | Miscellaneous | % App of IT Budget * | |
| | Cost | outsourced IT costs. | O% Other App * | |
| | | | Outsourced IT Budget | |
| 27 | Other Cost | Total miscellaneous | Internal Other Cost + | |
| | | costs. | Outsourced Other Cost | |
| 28 | HW SW Network | All costs associated | Hardware Cost + | |
| | Cost | with physical IT | Software Cost + | |
| | | equipment. | Network Cost | |
| 29 | Cons Oth Cost | All costs associated | Consulting Cost + Other | |
| | | with consultants and | Cost | |
| | | miscellaneous items. | | |
| 30 | IGC Sr Mgr | Gross cost | % Sr Mgr Internal * | |
| | | associated with | Average Salary Sr Mg | |
| | | internal Senior | | |
| | | Managers | | |
| 31 | I% Sr Mgr Cost | The percent of internal | IGC Sr Mgr/ Sum IGC | |
| | | senior managers in an | | |
| | | application, by cost. | | |
| 32 | Sr Mgr Cost Internal | Costs associated with | FLS Cost * I% Sr Mgr | |
| | | internal senior | Cost | |
| | | managers. | | |
| 33 | Sr Mgr Internal | Number of internal | IT Staff Count Internal * | |
| | | senior managers. | Percent Sr Mgr Interns | |
| 34 | OGC Sr Mgr | Gross cost | % Sr Mgr Outsourced * | |
| | | associated with | Average Salary Sr Mg | |
| | | outsourced Senior | | |
| | | Managers | | |
| 35 | O% Sr Mgr Cost | The percent of | OGC Sr Mgr / Sum OGC | |
| | | outsourced senior | | |
| | | managers in an | | |
| | | application, by cost. | | |
| 36 | Sr Mgr Cost | Costs associated with | FLS Cost * Percent Sr | |
| | Outsourced | outsourced senior | Mgr Outsourced | |
| | | managers. | | |
| 37 | Sr Mgr Outsourced | Number of outsourced | IT Staff Count | |
| | | senior managers. | Outsourced * O% Sr | |
| | | | Mgr Cost | |
| 38 | Sr Mgr | Total number of senior | Sr Mgr Internal + Sr Mgr | |
| | | managers. | Outsourced | |
| 39 | Sr Mgr Cost | Total cost associated | Sr Mgr Cost Internal + | |
| | | with senior managers. | Sr Mgr Cost | |
| | | | Outsourced | |
| 40 | IGC New Dev | Gross cost | % New Dev Internal * | |
| | | associated with | Average Salary New | |
| | | internal New | Dev | |
| | | development staff | | |
| 41 | I% New Dev Cost | The percent of internal | IGC New Dev / Sum IGC | |
| | | new development | | |
| | | staff in an application, | | |
| | | by cost. | | |
| 42 | New Dev Cost | Costs associated with | FLS Cost * I% New Dev | |
| | Internal | internal new | Cost | |
| | | development staff. | | |
| 43 | New Dev Internal | Number of internal | IT Staff Count Internal * | |
| | | new development | Percent New Dev | |
| | | staff. | Internal | |
| 44 | OGC New Dev | Gross cost | % New Dev | |
| | | associated with | Outsourced * Average | |
| | | outsourced New | Salary New Dev | |
| | | development staff | | |
| 45 | O% New Dev Cost | The percent of | OGC New Dev / Sum | |
| | | outsourced new | OGC | |
| | | development staff in | | |
| | | an application, by | | |
| | | cost. | | |
| 46 | New Dev Cost | Costs associated with | FLS Cost * O% New | |
| | Outsourced | outsourced new | Dev Cost | |
| | | development staff. | | |
| 47 | New Dev | Number of outsourced | IT Staff Count | |
| | Outsourced | new development | Outsourced * Percent | |
| | | staff. | New Dev Outsourced | |
| 48 | New Dev | Total number of new | New Dev Internal + | |
| | | development staff. | New Dev Outsourced | |
| 49 | New Dev Cost | Total cost associated | New Dev Cost Internal | |
| | | with new | + New Dev Cost | |
| | | development staff. | Outsourced | |
| 50 | IGC Maint Dev | Gross cost | % Maint Dev Internal * | |
| | | associated with | Average Salary Maint | |
| | | internal Maintenance | Dev | |
| | | development staff | | |
| 51 | I% Maint Dev Cost | The percent of internal | IGC Maint Dev / Sum | |
| | | maintenance | IGC | |
| | | development staff in | | |
| | | an application, by | | |
| | | cost. | | |
| 52 | Maint Dev Cost | Costs associated with | FLS Cost * Percent | |
| | Internal | internal maintenance | Maint Dev Internal | |
| | | development staff. | | |
| 53 | Maint Dev Internal | Number of internal | IT Staff Count Internal * | |
| | | maintenance | Percent Maint Dev | |
| | | development staff. | Internal | |
| 54 | OGC Maint Dev | Gross cost | % Maint Dev | |
| | | associated with | Outsourced * Average | |
| | | outsourced | Salary Maint Dev | |
| | | Maintenance | | |
| | | development staff | | |
| 55 | O% Maint Dev Cost | The percent of | OGC Maint Dev / Sum | |
| | | outsourced | OGC | |
| | | maintenance | | |
| | | development staff in | | |
| | | an application, by | | |
| | | cost. | | |
| 56 | Maint Dev Cost | Costs associated with | FLS Cost * O% Maint | |
| | Outsourced | outsourced | Dev Cost | |
| | | maintenance | | |
| | | development staff. | | |
| 57 | Maint Dev | Number of outsourced | IT Staff Count | |
| | Outsourced | maintenance | Outsourced * Percent | |
| | | development staff. | Maint Dev Outsourced | |
| 58 | Maint Dev | Total number of | Maint Dev Internal + | |
| | | maintenance | Maint Dev Outsourced | |
| | | development staff. | | |
| 59 | Maint Dev Cost | Total cost associated | Maint Dev Cost Internal + | |
| | | with maintenance | Maint Dev Cost | |
| | | development staff. | Outsourced | |
| 60 | IGC Ops | Gross cost | % Ops Internal * | |
| | | associated with | Average Salary Ops | |
| | | internal Operations | | |
| | | development staff | | |
| 61 | I% Ops Cost | The percent of internal | IGC Ops / Sum IGC | |
| | | operations | | |
| | | development staff in | | |
| | | an application, by | | |
| | | cost. | | |
| 62 | Ops Cost Internal | Costs associated with | FLS Cost * I% Ops Cost | |
| | | internal operations | | |
| | | development staff. | | |
| 63 | Ops Internal | Number of internal | IT Staff Count Internal * | |
| | | operations | Percent Ops Internal | |
| | | development staff. | | |
| 64 | OGC Ops | Gross cost | % Ops Outsourced * | |
| | | associated with | Average Salary Ops | |
| | | outsourced | | |
| | | Operations | | |
| | | development staff | | |
| 65 | O% Ops Cost | The percent of | OGC Ops / Sum OGC | |
| | | outsourced operations | | |
| | | development staff in | | |
| | | an application, by | | |
| | | cost. | | |
| 66 | Ops Cost | Costs associated with | FLS Cost * O% Ops | |
| | Outsourced | outsourced operations | Cost | |
| | | development staff. | | |
| 67 | Ops Outsourced | Number of outsourced | IT Staff Count | |
| | | operations | Outsourced * Percent | |
| | | development staff. | Ops Outsourced | |
| 68 | Ops | Total number of | Ops Internal + Ops | |
| | | operations | Outsourced | |
| | | development staff. | | |
| 69 | Ops Cost | Total cost associated | Ops Cost Internal + Ops | |
| | | with operations | Cost Outsourced | |
| | | development staff. | | |
| 70 | IGC Tech | Gross cost | % Tech Internal * | |
| | | associated with | Average Salary Tech | |
| | | internal Technical | | |
| | | development staff | | |
| 71 | I% Tech Cost | The percent of internal | IGC Tech / Sum IGC | |
| | | technical development | | |
| | | staff in an application, | | |
| | | by cost. | | |
| 72 | Tech Cost Internal | Costs associated with | FLS Cost * I% Tech | |
| | | internal technical | Cost | |
| | | development staff. | | |
| 73 | Tech Internal | Number of internal | IT Staff Count Internal * | |
| | | technical development | Percent Tech Internal | |
| | | staff. | | |
| 74 | OGC Tech | Gross cost | % Tech Outsourced * | |
| | | associated with | Average Salary Tech | |
| | | outsourced Technical | | |
| | | development staff | | |
| 75 | O% Tech Cost | The percent of | OGC Tech / Sum OGC | |
| | | outsourced technical | | |
| | | development staff in | | |
| | | an application, by | | |
| | | cost. | | |
| 76 | Tech Cost | Costs associated with | FLS Cost * O% Tech | |
| | Outsourced | outsourced technical | Cost | |
| | | development staff. | | |
| 77 | Tech Outsourced | Number of outsourced | IT Staff Count | |
| | | technical development | Outsourced * Percent | |
| | | staff. | Tech Outsourced | |
| 78 | Tech | Total number of | Tech Internal + Tech | |
| | | technical development | Outsourced | |
| | | staff. | | |
| 79 | Tech Cost | Total cost associated | Tech Cost Internal + | |
| | | with technical | Tech Cost Outsourced | |
| | | development staff. | | |
| 80 | IGC Other Staff | Gross cost | % Other Staff Internal * | |
| | | associated with | Average Salary Other | |
| | | internal Other | Staff | |
| | | development staff | | |
| 81 | I% Other Staff Cost | The percent of internal | IGC Other Staff / Sum | |
| | | other development | IGC | |
| | | staff in an application, | | |
| | | by cost. | | |
| 82 | Other Staff Cost | Costs associated with | FLS Cost * I% Other | |
| | Internal | internal other | Staff Cost | |
| | | development staff. | | |
| 83 | Other Staff Internal | Number of internal | IT Staff Count lnternal * | |
| | | other development | Percent Other Staff | |
| | | staff. | Internal | |
| 84 | OGC Other Staff | Gross cost | % Other Staff | |
| | | associated with | Outsourced * Average | |
| | | outsourced Other | Salary Other Staff | |
| | | development staff | | |
| 85 | O% Other Staff | The percent of | OGC Other Staff / Sum | |
| | Cost | outsourced other | OGC | |
| | | development staff in | | |
| | | an application, by | | |
| | | cost. | | |
| 86 | Other Staff Cost | Costs associated with | FLS Cost * O% Other | |
| | Outsourced | outsourced other | Staff Cost | |
| | | development staff. | | |
| 87 | Other Staff | Number of outsourced | IT Staff Count | |
| | Outsourced | other development | Outsourced * Percent | |
| | | staff. | Other Staff Outsourced | |
| 88 | Other Staff | Total number of other | Other Staff Internal + | |
| | | development staff. | Other Staff Outsourced | |
| 89 | Other Staff Cost | Total cost associated | Other Staff Cost | |
| | | with other | Internal + Other Staff | |
| | | development staff. | Cost Outsourced | |
| 90 | Sum OGC | Total gross cost of | OGC Sr Mgr + OGC | |
| | | outsourced | New Dev + OGC Maint | |
| | | resources. | Dev + OGC Ops + OGC | |
| | | | Tech + OGC Other | |
| | | | Staff | |
| 91 | Sum IGC | Total gross cost of | IGC Sr Mgr + IGC New | |
| | | internal resources. | Dev + IGC Maint Dev + | |
| | | | IGC Ops + IGC Tech + | |
| | | | IGC Other Staff | |
| 92 | IT Staff Cost | Total IT Staff cost. | Sr Mgr Cost + New Dev | |
| | | | Cost + Maint Dev Cost + | |
| | | | Ops Cost + Tech Cost + | |
| | | | Other Staff Cost | |
| 93 | IT Budget | Total IT budget across | HW SW Network Cost + | |
| | | all budget categories. | Cons Oth Cost + IT | |
| | | | Staff Cost | |
| 94 | Typical Availability | The percent of time a | ( Scheduled Hours - | Calculated on a |
| | | platform is generally | Downtime) / Scheduled | platform basis, |
| | | up and available. | Hours | then applied to |
| | | | | each application |
| | | | | by platform. |
| 95 | Impact of Outage | The percent impact to | For each Outage | |
| | | the business of an | Impact, use value as: | |
| | | unexpected outage. | 1 = 10% | |
| | | | 2 = 20% | |
| | | | 3 = 40% | |
| | | | 4 = 60% | |
| | | | 5 = 80% | |
| | | | 6 = 100% | |
| 96 | Unavailability | The liability or lost | Total Application Value | |
| | | opportunity to the | * (1 - Typical | |
| | | business because | Availability) * Impact of | |
| | | applications were | Outage | |
| | | down. | | |
| 97 | Major impact | The impact to the | For each Daily Impact, | |
| | | business of a major | use value as: | |
| | | outage. | 1 = 2.5 | |
| | | | 2 = 4 | |
| | | | 3 = 6 | |
| | | | 4 = 7 | |
| | | | 5 = 9.5 | |
| 98 | Mitigation | The relative protection | For each DR Method, | |
| | | provided by a specific | use value as: | |
| | | disaster recovery | 1 = 1 | |
| | | methodology. | 2 = 1.5 | |
| | | | 3 = 2 | |
| | | | 4 = 3 | |
| | | | 5 = 4 | |
| | | | 6 = 5 | |
| 99 | DR Budget Percent | The typical cost in | For each DR Method, | |
| | | hardware, software | use value as: | |
| | | and networking of | 1 = 3% | |
| | | disaster recovery | 2 = 7% | |
| | | methodologies. | 3 = 18% | |
| | | | 4 = 26% | |
| | | | 5 = 60% | |
| | | | 6 = 100% | |
| 100 | DR Cost | The cost of disaster | HW SW Network Cost * | |
| | | recovery precautions. | DR Budget Percent | |
| 101 | Potential Total Loss | Cost of potential | (Total Application Value | |
| | | catastrophic failure | * Impact of Outage * (1 - | |
| | | per application or | Typical Availability) * | |
| | | each platform | Major Impact) / | |
| | | | Mitigation | |
| 102 | DR Cost/Loss | The relative cost of | DR Cost / Potential Total | |
| | | disaster recovery | Loss | |
| | | compared to the cost | | |
| | | incurred. | | |
| 103 | Base inflexibility | The cost associated | Maint Dev * Average | |
| | | with maintenance | Salary Maint Dev | |
| | | resources. | | |
| 104 | Inflexibility | The impact of | Base Inflexibility * (Sum | |
| | | maintenance and | of Total Application | |
| | | changes on the value | Value / Sum of Total IT | |
| | | of each application or | Budget) | |
| | | each platform | | |
| 105 | Net Application | The net value of each | Total Application Value - | |
| | Value | application, taking | Total IT Budget - | |
| | | costs associated with | Internal User Cost - | |
| | | each application or | Potential Total Loss - | |
| | | each platform into | Inflexibility | |
| | | account | | |

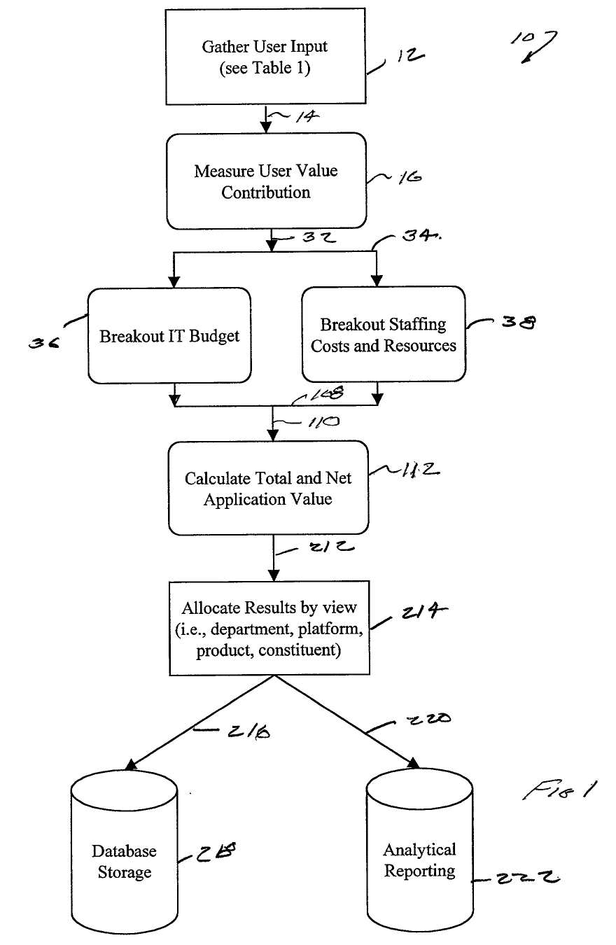

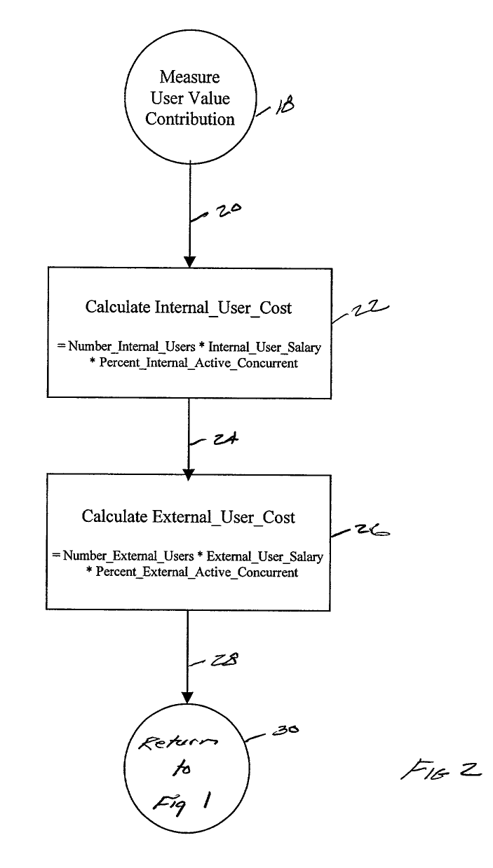

Referring to FIG. 1, an overall representation of the method and system at hand is presented as represented generally at 10. As a first step in the method, as represented at block 12, the user input is gathered. This input is represented by the field inputs at the left of the tabulation. In general, the listing will follow the flow charts of the drawings. It may be observed that the input fields are somewhat staff oriented and the staffing data which is collected is concerned with both staff representing internal or regularly employed employees as well as staff. In the latter regard, it is quite conventional in current organizations to employ services of external entities, for example, to handle payroll and the like. The field inputs also incorporate application and organization IT budgets and further calls upon the organization to elect evaluations of the effect of down time or failure of components of the IT system. These data then are treated with the methodology to provide the noted total and net application values for the IT system and the variety of analytical reports which can be produced from the data. Upon completion of data gathering, then, as represented at arrow 14 and block 16, the method then carries out a measurement of user value contribution. The latter terms, sometimes referred to as base application value, and the measurement is represented in FIG. 2. Referring to the latter figure, this routine is shown to commence with node 18 and arrow 20. Arrow 20 extends to block 22 which provides for the calculation of internal user cost. As represented in the block and shown at row 1 of Table 2, this value is derived as the number of internal users times the internal user salary multiplied by the percent of internal active concurrent users. This data is derived with respect to fields 1 through 3 of Table 1.

The terms “active concurrent” are utilized to define the utilization of the application by what may amount to a broad number of users, many of whom generate such use for only a portion of the measurement interval. Thus, the figure may represent the total number of users of the system over an interval. That number of users then is multiplied by the percentage representing those active and concurrent over the measurement interval. That percentage is gathered at input field 5 of Table 1. The number represents equivalent or effective people. An active concurrent user is a user who is logged on to the given application and is making extensive use of it. Essentially, an active concurrent user represents an individual that is fully dedicated to using the application, even if it is not the same individual. For example, a particular user of an application may only spend 10% of his or her day using the application. Ten individuals spending 10% of their time during a given day who are actively using an application or set of applications represents one active concurrent user.

Next as represented at arrow 24 and block 26, the methodology carries out a calculation of the external user cost. External user is an individual who is not a regular employee of the organization who utilizes the tool. External users may represent any of a broad variety of people. For example, where web sites are utilized for product ordering purposes, it is the potential purchaser who becomes an external user. Additionally, as noted above, separate entities may be employed in an outsourcing approach to carry out tasks which otherwise might be accomplished with in-house personnel. However, the methodology of the invention assimilates the efforts of these external users in developing its final results. Developing the external user cost, the number of external users is accessed from input field 4 as set forth in Table 1 and that number is multiplied by the external user salary as developed at input field 6 of Table 1. In turn, that product is multiplied by the percent of external active concurrent users as inputted at field 5 of Table 1.

As represented at arrow 28 and node 30, the method then returns to FIG. 1 and arrows 32 and 34. Arrow 34 is seen to be bifurcate in structure and extends to the simultaneous considerations represented at blocks 36 and 38. Block 36 looks to a procedure providing for the breakout of the IT budget and block 38 looks to a breakout of staffing costs and resources for the application or applications at hand.

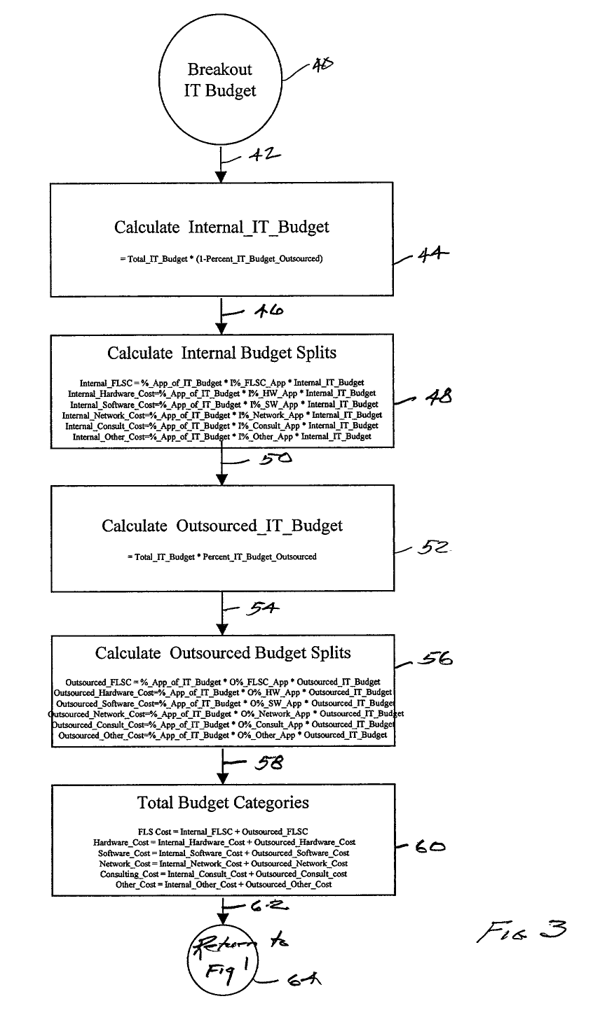

Referring to FIG. 3, the procedure for carrying out a breakout of the IT budget as represented at block 36 is set forth. In the figure, the procedure is seen to commence at node 40 and arrow 42 extending to block 44. This calculation is represented at row 8 of Table 2 and calls for a multiplication of the total IT budget as provided at input field 11 of Table 1. That total IT budget then is multiplied by one minus the percent IT budget which is outsourced. That percentage is accessed from input field 12 of Table 1. Note that at this juncture the procedure is concerned with that part of the IT budget which is, in effect, in-house as opposed to being outsourced.

A procedure then continues as represented at arrow 46 and block 48 which describes a calculation of the internal budget splits. Note that with the procedure there is assigned a number, for example, 6, of select cost categories as may be gleaned from the IT budget. Again, it is the internal budget which is under consideration at this juncture in the procedure. While a greater or lesser number of these select categories may be employed, those listed herein are fully loaded staff costs for an application (FLSC): hardware cost, software cost, network cost, the cost of consultant (Consult Cost), and other or miscellaneous cost. As represented in block 48 and row 10 of Table 2, the internal FLSC is derived as the percent of the given application of the IT budget as represented at input field 13 in Table 1, multiplied by the percent of the fully loaded staff cost for the application as inputted at field 14 of Table 1, and in turn multiplied by the internal IT budget as derived in conjunction with block 44. Next, the internal hardware cost is developed as described in conjunction with row 13 of Table 2 and represent a percent of the application in the IT budget (%_App_of_IT_Budget) (supra) multiplied by the percentage represented for the application by hardware (I % HW App) as derived from input field 15 in Table 1 which then is multiplied by the internal IT budget (supra). Internal software cost represents the product of the percentage for this application of the IT budget (supra) multiplied by the internal percentage of the software for the application as retrieved from input field 16 which, in turn, is multiplied by the internal IT budget (supra). Next, the internal software cost is developed as the product of the percentage of this application in the IT budget (supra) multiplied by the internal percentage for software with respect to this application as retrieved from input field 16 in Table 1 and that product then is multiplied by the value of the internal IT budget (supra). The internal network cost is derived as described at row 19 of Table 2. As noted in that tabulation, the internal network cost is the cost of networking including wiring routers and the like which are bought and maintained internally in the organization. That cost is derived as the percentage of the IT budget for this application (supra) multiplied by the internal percentage of the internal network represented in this application as retrieved from input field 17 of Table 1, the resultant product being multiplied by the internal IT budget (supra). The internal consultant cost, i.e., in-house consultants, is developed as the product of the percentage for this application of the IT budget (supra) multiplied by the internal percentage of consultant cost for the given application as retrieved from input field 18 of Table 1, that product, as before, being multiplied by the internal IT budget (supra). Finally, the internal other or miscellaneous cost is developed as the product of the percentage of this application within the IT budget multiplied by the percentage for this other component as retrieved from input field 19 shown in Table 1, that product being multiplied, as before, by the internal IT budget (supra).

Those internal budget splits being developed as represented at block 48, the procedure then proceeds as represented at arrow 50 and block 52. The procedures as described in conjunction with blocks 44 and 48 are repeated, however, this repetition is concerned with outsourced activities. Accordingly, block 52 describes the calculation of the outsourced IT budget, a procedure also described in conjunction with row 9 of Table 2. The outsourced IT budget is computed as the total IT budget (supra) multiplied by the percentage of the IT budget which is outsourced, a percentage retrieved from field 12 shown in Table 1.

The procedure then continues as represented at arrow 54 and block 56 to calculate the outsourced budget splits. This calculation involves the same select cost categories of the IT budget as were utilized in conjunction with the procedure represented at block 48. In this regard, the outsourced FLSC is computed as described at row 11 in Table 2 as being the product of the percentage for the instant application of the IT budget (supra) multiplied by the source percentage of the application for the FLSC as retrieved from input field 20 listed in Table 1. The outsourced hardware cost is derived as the percentage for the instant application of the IT budget (supra) multiplied by the percentage of the outsourced hardware for the given application as retrieved from field 21 listed in Table 1 which, in turn, is multiplied by the outsourced IT budget as developed in conjunction with block 52. The outsourced software cost is developed as the percentage of the budget represented by the instant application (supra) multiplied by the percentage represented by outsourced software for the present application as retrieved from field 22 shown in Table 1 and multiplied by the outsourced IT budget developed in conjunction with block 52. The outsourced consulting costs are derived as the product of the percentage of the IT budget represented by the instant application (supra) multiplied by the percentage represented by outsourced consultants for the instant application as retrieved from field 24 shown in Table 1 and that product is multiplied by the outsourced IT budget developed in conjunction with block 52. The outsourced other or miscellaneous cost is developed as the product of the percentage represented by the instant application in the IT budget (supra) multiplied by the percentage represented by such other or miscellaneous outsourced cost for the instant application as retrieved from field 25 shown in Table 1 and the resultant product is multiplied by the value of the outsourced IT budget as developed in conjunction with block 52.

Next, as represented at arrow 58 and block 60, the outsourced and internal category values are summed together by data which is useful for developing any of the variety of reports which may be generated with the methodology. In this regard, the values developed at block 48 are added with the corresponding values developed in conjunction with block 56. Note, that the FLSC as is described at row 12 in Table 2 is represented as the value of the internal FLSC added with the outsourced FLSC. Hardware cost is computed as represented at row 15 in Table 2 and is the sum of the internal hardware cost and the outsourced hardware cost. Software cost is developed as represented at row 18 in Table 2 and is the sum of the internal software cost and the outsourced software cost. Network cost is developed as represented at row 21 in Table 2 and represents the sum of the internal network cost and the outsourced network cost. Consulting cost is developed as represented at row 24 in Table 2 and represents the sum of the internal consultant cost and the outsourced consultant cost. Other or miscellaneous cost is developed as represented at row 27 in Table 2 and is derived as the sum of the internal other cost and the outsourced other cost. The procedure then, as represented at arrow 62 and node 64 returns to FIG. 1 and bifurcate arrow 34 extending additionally to the breakout of staffing cost and resources as represented at block 38.

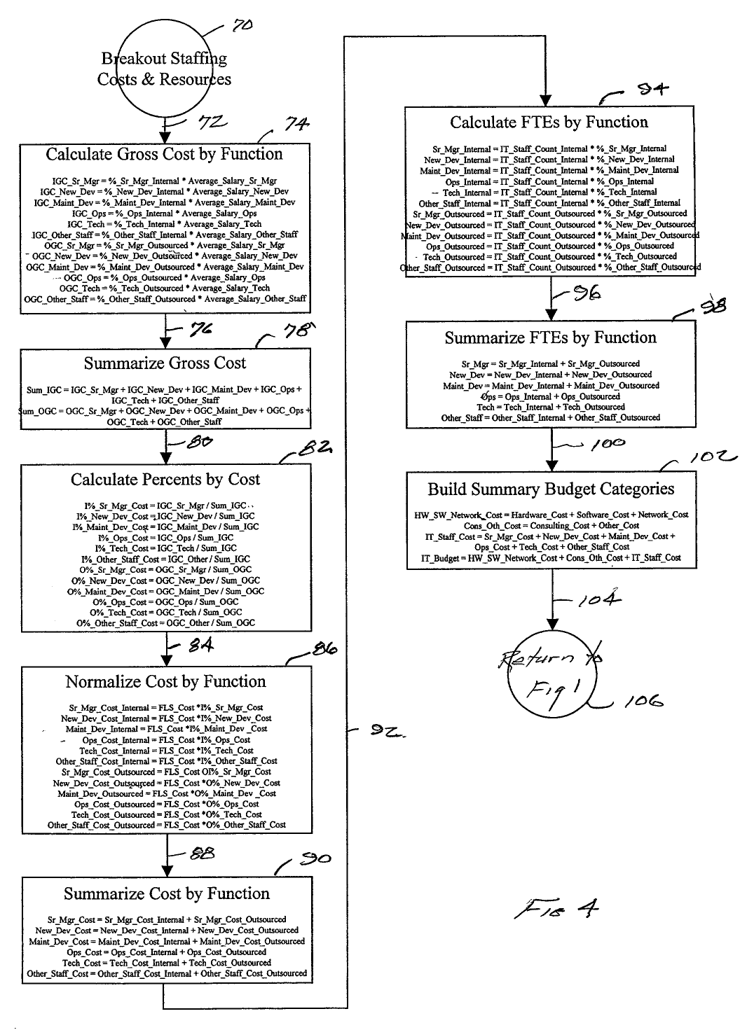

Turning to FIG. 4, the breakout represented at block 38 is illustrated at an enhanced level of detail. In carrying out this staffing breakout of the IT budget, the methodology employs a select number of staff functions. For the instant demonstration, six such staff functions are represented, it being understood that more or fewer such staff function designations may be employed with the procedure. These staff functions are: senior managers (Sr_Mgr); staff engaged in new developments (New_Dev); staff involved in maintenance development, for example, upgrading existing tools and the like (Maint_Dev); operations staff, i.e., people who, for example, maintain a file server, assure proper facility wiring and the like (Ops); technology staff (Tech); and other staff or people such as secretaries, interns, trainers, and the like (Other_Staff).

The breakout procedure is shown in FIG. 4 as commencing at node 70 and arrow 72 extending to block 74. At block 74 the calculation of gross cost by the above-identified functions is represented. Note, that the calculation for the staff functions are carried out with respect to internal staff and outsourced staff.

The internal gross cost for senior manager staff (IGC_Sr_Mgr) is derived as represented at row 30 in Table 2 and is derived as a product of the percentage for internal senior managers retrieved from field 33 shown in Table 1 multiplied by the average salary for senior managers as retrieved from field 26 shown in Table 1. The internal gross cost for internal staff involved with new development (IGC_New_Dev) is derived as the percentage of internal staff involved with new development (%_New_Dev_lnternal) retrieved from field 34 shown in Table 1 multiplied by the average salary for staff involved in new development retrieved from field 27 shown in Table 1. The internal gross cost for internal staff involved in maintenance development (IGC_Maint_Dev) is computed as represented at row 50 in Table 2 as the product of the percent of internal staff engaged in maintenance development (%_Maint_Dev_lnternal) as retrieved from field 35 shown in Table 1 and the average salary for maintenance development staff as retrieved from field 28 shown in Table 1. The gross cost for internal staff involved in operations (IGC_Ops) is derived as represented at row 60 in Table 2 as the product of the percentage of internal operations staff (%_Ops_Internal) as retrieved from field 36 shown in Table 1 and the average salary for staff involved in operations (Average_Salary_Ops) as retrieved from field 29 as shown in Table 1. The gross cost for staff involved in technology functions (IGC_Tech) is derived as represented at row 70 shown in Table 2 as a product of the percentage of internal staff involved in technology (%_Tech_Internal) as retrieved from field 37 shown in Table 1 and the average salary for such technical staff (Average_Salary_Tech) retrieved from field 30 shown in Table 1. The gross cost for internal other staff (IGC_Other_Staff) is derived as represented at row 80 shown in Table 2 and is the product of the percentage of internal staff associated with other functions (%_Other_Staff_Internal) as retrieved from field 38 shown in Table 1 and the average salary for internal other staff (Average_Salary_Other_Staff) as retrieved from field 31 shown in Table 1.

The calculation of gross cost by function next turns to outsourced staff. Block 74 shows the computation of the gross cost of outsourcing senior managers (OGC_Sr_Mgr) as described at row 34 in Table 2. This cost is developed as the product of the percent of outsourced senior managers (%_Sr_Mgr_Outsourced) as retrieved from field 40 shown in Table 1 and the average salary for senior managers (supra). The gross cost for outsourced staff involved in new development (OGC_New_Dev) as described at row 44 in Table 2 is derived as the product of the percentage of outsourced staff concerned with new developments (%_New_Dev_Outsourced) retrieved from field 41 shown in Table 1 multiplied by the average salary of staff involved with new development (supra). The gross cost for outsourced staff involved in maintenance development (OGC_Maint_Dev) as described at row 54 in Table 2 is derived as the product of the percentage of outsourced staff engaged in maintenance (%_Maint_Dev_Outsourced) retrieved from field 42 shown in Table 1 and the average salary for staff involved in maintenance development (supra).

The gross cost for outsourced staff involved in operations (OGC_Ops) is derived as represented at row 64 in Table 2 as the product of the percentage of outsourced staff involved in operations (%_Ops_Outsourced) retrieved from field 43 shown in Table 1 and the average salary for staff involved in operations (supra). The gross cost for outsourced technical staff (OGC_Tech) is derived, as described at row 74 shown in Table 2, as the product of the percentage of outsourced technical staff (%_Tech_Outsourced) as retrieved from field 44 shown in Table 1 and the average salary for the technical staff (supra). Finally, the gross cost for outsourced other staff (OGC_Other_Staff) as described at row 84 as Table 2 is derived as the product of the percentage of outsourced other staff (%_Other_Staff_Outsourced) as retrieved from field 45 shown in Table 1 and the average salary for other staff (supra).

The procedure then continues as represented at arrow 76 in block 78 to summarize the calculated gross cost. This component of the procedure basically derives the gross cost internally and outsourced for all of the above staff functions. Accordingly, the summation of the internal gross cost (Sum_IGC) is computed as represented at row 91 shown in Table 2 as the sum of the internal gross cost staff functions developed in conjunction with block 74. Correspondingly, the sum of the outsourced gross cost for the six functions shown in block 74 (Sum_OGC) is computed as represented at row 90 in Table 2 as the sum of the outsourced gross cost derived in conjunction with block 74.

The procedure then continues as represented at arrow 80 and block 82 to determine percentages by cost with respect to the sums developed in conjunction with block 78. The percentage of the cost of internal senior managers (I %_Sr_Mgr_Cost) is derived as described at row 31 in Table 2 as the ratio of the gross cost for internal staff senior managers (supra) divided by the sum of the internal gross cost in block 78 (supra). The percentage for internal staff involved in new development (I %_New_Dev_Cost) is derived as described at row 41 in Table 2 by dividing the gross cost of internal new development staff (supra) by the sum of the internal gross cost (block 78). The percentage of the cost of internal staff involved in maintenance development (I %_Maint_Dev_Cost) is derived, as described at row 51 in Table 2, by dividing the gross cost for internal staff involved in maintenance development (supra) by the sum of the internal gross cost (block 78). The cost percentage for internal staff involved in operations (I %_Ops_Cost) is derived as described at row 61 in Table 2 by dividing the cost of internal staff (supra) by the sum of the gross cost for internal staff (block 78). The cost percentage for internal technical staff (I %_Tech_Cost) is derived as described at row 71 in Table 2 by the dividing the gross cost for internal technical staff (supra) by the sum of the gross cost for internal staff (block 78). The cost percentage for other internal staff (I %_Other_Staff_Cost) is derived, as described at row 81 in Table 2, by dividing the gross cost for internal staff involved in other duties (supra) by the summation of the gross cost for the internal staff (block 78).

The calculation of percents now turns to outsourced staff functions commencing with the determination of the cost percentage for outsourced senior managers (O %_Sr_Mg_Cost) as described at row 35 in Table 2. The percentage is derived by dividing the gross cost for outsourced senior managers (supra) by the sum of the gross cost for outsourced personnel (block 78). The cost percentage for outsourced staff involved in new development (O %_New_Dev_Cost) is developed as described at row 45 in Table 2 by dividing the gross cost for outsourced staff involved in new developments by the sum of the gross cost for outsourced staff (block 78). The cost percentage for outsourced staff involved in maintenance development (O %_Maint_Dev_Cost) is derived, as described at row 55 in Table 2, by dividing the gross cost for outsourced staff involved in maintenance development by the sum of the gross cost for outsourced staff (block 78).

The cost percentage for outsourced personnel involved in operations (O %_Ops_Cost) is derived as described at row 65 in Table 2 by dividing the gross cost for outsourced staff involved in operations by the sum of the outsourced gross cost of staff (block 72). The cost percentage for outsourced technical personnel (O %_Tech_Cost) is derived, as described at row 75 in Table 2, by dividing the gross cost for outsourced technical personnel by the sum of the gross cost of personnel (block 78). The cost percentage for outsourced other staff (O %_Other_Staff_Cost) is derived, as described at row 85 in Table 2, by dividing the gross cost of outsourced other staff by the sum of the gross cost for personnel (block 78).

The procedure then proceeds as represented at arrow 84 and block 86 to normalize the cost by function. Typically in gathering inputs from the organization, as described in conjunction with block 12 in Table 1, the breakouts for staff are given by personnel count as opposed to budget dollars. With the instant normalization function, a more accurate representation of the identified staff functions, both internal and outsourced, are derived utilizing the cost percentages developed as described in conjunction with block 82 and the totally loaded staff cost (FLS_Cost) as derived in conjunction with the total budget categories described in conjunction with block 60 in FIG. 3.

The normalized senior manager internal staff (Sr_Mgr_Cost_Internal) is derived, as described at row 32 in Table 2, by driving the product of the fully loaded internal staff cost and the corresponding calculated percentage for internal senior managers (block 82). The normalized cost for internal new development staff (New_Dev_Cost_Internal) is derived, as described at row 42 in Table 2, as the product of the fully loaded staff cost and the cost percentage for internal new development staff (block 82). The normalized cost for internal maintenance development staff (Maint_Dev_Cost_Internal) is developed, as described at row 52 in Table 2, as a product of the fully loaded staff cost and the cost percentage for internal staff involved in operations (block 82). The normalized cost for internal staff involved in operations is derived, as described at row 62 in Table 2, as the product of the fully loaded staff cost and the cost percentage for internal staff involved in operations (block 82). The normalized cost for internal staff involved with technology (Tech_Cost_Internal) is derived, as described at row 72 in Table 2, as the product of the fully loaded staff cost and the cost percentage for internal staff involved with technology. The normalized cost for internal staff involved in other categories (Other_Staff_Cost_Internal) is derived, as described at row 82 in Table 2, as the product of the fully loaded staff cost and the cost percentage for other internal staff (block 82).

Now looking to the normalization of the outsourced staff cost, the normalized cost for outsourced senior managers (Sr_Mgr_Cost_Outsourced) is derived, as described at row 36 in Table 2, as the product of the fully loaded staff cost and the cost percentage for outsourced senior managers (block 82). The normalized cost for outsourced new development staff (New_Dev_Cost_Outsourced) is derived, as described at row 46 in Table 2, as the product of the fully loaded staff cost and the cost percentage for outsourced new development staff (block 82). The normalized cost for outsourced staff involved in maintenance development (Maint_Dev_Cost_Outsourced) is derived, as represented at row 56 in Table 2, as the product of the fully loaded staff cost and the cost percentage for outsourced maintenance development personnel (block 82). The normalized cost for outsourced personnel involved in operations (Ops_Cost_Outsourced) is derived, as described at row 66 in Table 2, as a product of the fully loaded staff cost and the cost percentage for outsourced operations personnel. The normalized cost for outsourced personnel involved in technology (Tech_Cost_Outsourced) is derived, as described at row 76 in Table 2, as a product of the fully loaded staff cost and the cost percentage for technology personnel (block 82). The normalized cost for outsourced other staff (Other_Staff_Cost_Outsourced) is derived, as described row 86 in Table 2, as a product of the fully loaded staff cost and the cost percentage for outsourced other staff (block 82).

The procedure then proceeds as represented by arrow 88 and block 90 to summarize the costs by function. This is achieved by summing the internal and outsourced normalized staff function costs as described in conjunction with block 86. In effect, a total cost is derived for each staff position or function. Accordingly, the senior manager cost (Sr_Mgr_Cost) is derived, as described at row 39 in Table 2, as the sum of the internal senior manager cost and the outsourced senior manager cost (block 86). The sum of new development cost (New_Dev_Cost) is derived, as described at row 49 in Table 2, as the sum of the cost of the internal staff engaged in new development and outsourced personnel engaged in new development (block 86). The summed maintenance development cost (Maint_Dev_Cost) is derived, as described at row 59 in Table 2, as the sum of the normalized internal maintenance development staff cost and the outsourced normalized cost for maintenance development personnel (block 86). The summed operation staff cost (Ops_Cost) is derived, as described at row 69 in Table 2, as the sum of the normalized internal operation staff cost and the normalized outsourced operations personnel cost (block 86). The summed technical staff cost (Tech_Cost) is derived, as described in conjunction with row 79 in Table 2, as the sum of the normalized internal technical staff cost and the normalized outsourced technical staff cost (block 86). The summed other staff cost (Other_Staff_Cost) is derived, as described in conjunction with row 89 in Table 2, as the sum of the normalized cost of the internal other staff and the normalized cost of the outsourced other staff or personnel.

The procedure then continues as represented by arrow 92 and block 94 to calculate the numbers of fulltime equivalent persons associated with each of the select staff functions. In this regard, the program has developed costs by function and now turns to determining the total number of staff for each of these functions. As before, these functions are considered separately in terms of internal staff and outsourced staff. The equivalent senior manager internal staff (Sr_Mgr_Internal) is derived, as described at row 33 in Table 2, as a product of the internal IT staff count (IT_Staff_Count_Internal) retrieved from field 32 as shown in Table 1 and the percentage of internal senior managers (%_Sr_Mgr_lnternal) as retrieved from field 33 shown in Table 1. The equivalent internal new development staff (New_Dev_Internal) is derived, as described at row 43 in Table 2, as the product of the internal staff count (supra) and the percent of internal new development staff (%_New_Dev_Internal) as retrieved from field 34 shown in Table 1. Fulltime equivalent internal maintenance development staff (Maint_Dev_Internal) is derived, as described at row 53 in Table 2, as a product of the IT internal staff count (supra) and the percentage of internal maintenance development staff (%_Maint_Dev_Internal) as retrieved from field 35 shown in Table 1. The fulltime equivalent internal operations staff (Ops_Internal) is derived, as described at row 63 in Table 2, as the product of the internal IT staff count (supra) and the percentage of internal operations staff (%_Ops_lnternal) as retrieved from field 36 shown in Table 1. The fulltime equivalent internal technical staff (Tech_lnternal) is derived, as described at row 73 in Table 2, as the product of the internal IT staff count (supra) and the percentage of internal technical staff (%_Tech_Internal) retrieved from field 37 shown in Table 1. The fulltime equivalent count for internal other staff (Other_Staff_Internal) is derived, as described at row 83 in Table 2, as the product of the internal IT staff count (supra) and the percentage of internal other staff (%_Other_Staff_lnternal) as retrieved from field 38 shown in Table 1.

The fulltime equivalent calculation now turns to staff function grouping with respect to outsourced personnel. In this regard, the fulltime equivalent outsourced senior manager staff (Sr_Mgr_Outsourced) is derived, as described at row 37 in Table 2, as the product of the outsourced IT staff (IT_Staff_Count_Outsourced) retrieved from field 39 shown in Table 1 and the percentage of outsourced senior managers (%_Sr_Mgr_Outsourced) retrieved from field 40 of Table 1. The fulltime equivalent count of outsourced new development staff (New_Dev_Outsourced) is derived, as described at row 47 in Table 2, as the product of the outsourced IT staff count (supra) and the percent of new development outsourced personnel (%_New_Dev_Outsourced) as retrieved from field 41 shown in Table 1. A fulltime equivalent count for outsourced maintenance development personnel (Maint_Dev_Outsourced) is derived, as described at row 57 in Table 2, as the product of the outsourced IT staff count (supra) and the percentage of outsourced maintenance development personnel (%_Maint_Dev_Outsourced) as retrieved from field 42 shown in Table 1. The fulltime equivalent number of outsourced operations staff or personnel (Ops_Outsourced) is derived, as described at row 67 in Table 2, as the product of the outsourced IT staff count (supra) and the percentage of outsourced operations personnel (%_Ops_Outsourced) retrieved from field 43 shown in Table 1. A fulltime equivalent count for outsourced technical personnel or staff (Tech_Outsourced) is derived, as described at row 77 in Table 2, as the product of the outsourced IT staff count (supra) and the percentage of outsourced technical personnel (%_Tech_Outsourced) as retrieved from field 44 shown in Table 2. Fulltime equivalent outsourced other staff (Other_Staff_Outsourced) is derived, as described at row 86 in Table 2, as the product of the outsourced IT staff count (supra) and the percentage of other staff (%_Other_Staff_Outsourced) as retrieved from field 45 shown in Table 1.

The program then continues as represented at arrow 96 and block 98 to summarize the fulltime equivalent staff by the noted select functions. The fulltime senior manager (Sr_Mgr) is derived, as described at row 38 of Table 2, as the sum of the fulltime equivalent internal senior managers and the fulltime equivalent outsourced senior managers (block 94). A fulltime equivalent new development staff (New_Dev) is derived, as described at row 48 in Table 2, as the sum of the internal fulltime equivalent new development staff and outsourced fulltime equivalent new development staff (block 94). The summed fulltime equivalent maintenance development staff (Maint_Dev) is developed, as described at row 58 in Table 2, as the sum of the fulltime equivalent internal maintenance development staff and the outsourced fulltime equivalent maintenance development staff (block 94). The summed fulltime equivalent operations staff (Ops) is derived, as represented at row 68 in Table 2, as the sum of the fulltime equivalent internal operations staff and the fulltime equivalent outsourced operations staff (FIG. 94). The summed fulltime equivalent technology staff (Tech) is derived, as described at row 78 in Table 2, as the sum of the internal fulltime equivalent technical staff and the fulltime equivalent outsourced technical staff (block 94). The summarized fulltime equivalent other staff (Other_Staff) is derived, as described at row 88 in Table 2, as the sum of the internal fulltime equivalent other staff and fulltime equivalent outsourced other staff.

The program then continues as represented arrow 100 and block 102 to build summary budget categories. This is an assembly of four budget group narrowly configured with the earlier derived data. This permits evaluation of the IT system at a less granular level. The initial group is shown as a hardware-software-network cost (HW_SW_N_Cost) which is derived, as described at row 28 in Table 2, as the sum of hardware cost (Hardware_Cost) which is derived, as described in conjunction with row 15 in Table 2, as the sum of the internal hardware cost and outsourced hardware cost. With hardware cost is software cost (Software_Cost), which is derived, as described at row 18 of Table 2, as the sum of internal software cost and outsourced software cost. Next summed for this major group is network cost (Network_Cost), which is derived, as represented at row 21 in Table 2, as the sum of internal network cost and outsourced network cost.

A next group is that of consulting cost plus other cost (Cons_Oth_Cost) which is derived, as described in conjunction with row 29 in Table 2, as the sum of consulting costs and other costs. Consulting cost (Consulting_Cost) is, in turn, derived, as represented at row 24 in Table 2, as the sum of the internal consult cost (FIG. 3, block 48) and the consult cost (FIG. 3, block 56). Consulting cost is summed with Other_Cost which is derived, as represented at row 27 in Table 2, as the sum of internal other cost (FIG. 3, block 48) and outsourced other cost (FIG. 3, block 56).

The IT staff cost (IT_Staff_Cost) is derived, as represented at row 92 of Table 2, as a summation of Sr_Mgr_Cost (block 90), New_Dev_Cost (block 90), Maint_Dev_Cost (block 90), Ops_Cost (block 90), Tech_Cost (block 90), and Other_Staff_Cost (block 90).

The major group identified as “IT_Budget” is derived, as represented at row 93 in Table 2. It represents a summation of the other groupings, i.e., HW_SW_Network_Cost, Cons_Oth_Cost, and IT_Staff_Cost. Its value should correspond with the total IT budget represented at field 11 in Table 1. The program then returns to FIG. 1 as represented at arrow 104 and node 106.

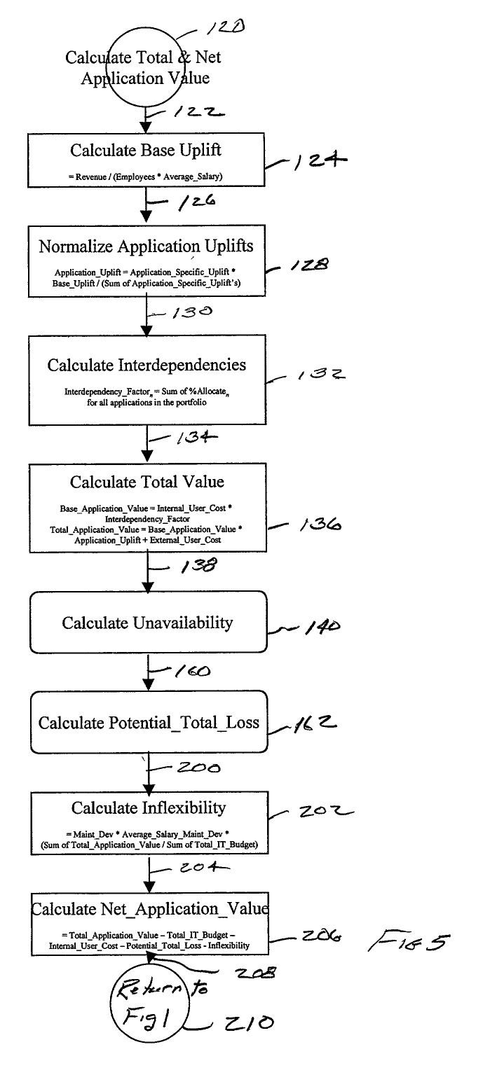

Looking to FIG. 1, duel arrow 108 is seen to extend from blocks 36 and 38 to arrow 110 and block 112 describing a calculation of total and net application value, metrics which are highly valuable to an assessment by management of the IT system of an organization. This procedure is illustrated at a higher level of detail in connection with FIG. 5. Looking to FIG. 5, the calculation procedure is shown to commence at node 120 and arrow 122 extending to block 124. As represented at block 124, a base uplift is calculated as represented at row 4 of Table 2, the base uplift is derived by dividing the organizations total revenue (Revenue), as retrieved from field 8 as shown in Table 1, divided by the product of the number of employees in the organization (Employees acquired from field 9 as shown in Table 1) and their average salary (Average Salary as acquired from field 10 as shown in Table 1). Accordingly, for the organization overall, each employee typically will bring so many dollars into the organization for each dollar the organization spends on them.

For each application within the IT system, there will be an application specific uplift provided by the organization as represented at field 7 of Table 1. As indicated by arrow 126 and block 128, the program next carries out a normalization of those application specific uplifts. This is carried out inasmuch as when requested for the applications specific uplifts, it is common for these values to represent an above average value for each application. The normalized application uplifts (Application_Uplift) is derived, as represented at row 5 of Table 2, as the product of the application specific uplift A_S_U (field 7, Table 1) and the Base_Uplift (block 124) divided by the sum of all of the application specific uplifts (Sum_of_Application_Specific_Uplift's).

The program then proceeds as represented at arrow 130 and block 132, the latter block providing for a calculation of interdependencies. Interdependencies feature of the methodology serves to recognize that some tools of an IT system will not be as useful were they not in the presence of another tool B. When such tools are present together, however, they may, as it were, evidence a certain synergism wherein the value of one is enhanced. For example, data warehouse may evidence a given lower usefulness in and of itself. However, where it is employed to compile and send data to another application, that other application may become much more valuable. Accordingly, the program permits the organization to allocate some part of value from one application to another using the above scenario, perhaps 25% of the value of the noted data warehouse is properly present in an associated executive system. That 25% improvement, therefore, is assigned to the executive system. As described at row 3 of Table 2, the interdependency factor is the sum of the % Allocateₙ as derived from field 46 shown in Table 1, for all applications in the organizations' portfolio. It will represent the sum of the % Allowcateₙ₁ through % Allocateₙᵢ. As noted at row 3 of Table 2, the noted sum is for each application n, in the portfolio of applications from 1 to i where i is the last application in the portfolio.

The program then continues, as represented at arrow 134 and block 136, to carry out a calculation of total application value. In driving the total value, the Base Application Value initially is derived as described in conjunction with row 6 in Table 2. The Base Application Value is derived as the product of the Internal_User_Cost as developed in conjunction with block 22 in FIG. 2 and the interdependency factor I_Factor as derived in conjunction with block 132 of the instant figure.

As described in conjunction with row 7 of Table 2, Total_Application_Value is derived in conjunction with all uplifts and interdependencies taken into account per application. Accordingly, is derived as the Base_Application_Value times the sum of the Application_Uplift (block 128) and External_User_Cost (FIG. 2, block 26).

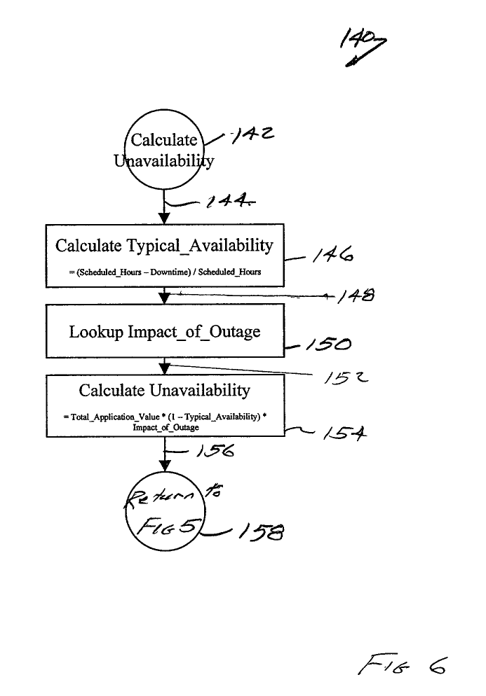

As represented at arrow 138 and block 140, the program then carries out a calculation of unavailability. This is an evaluation of a condition wherein the system is down or otherwise unavailable. Referring to FIG. 6, this feature of the methodology is illustrated at an enhanced level of detail. This component of the program is entered as represented at node 142 and arrow 144 extending to block 146. As described at row 94 of Table 2, block 146 is concerned with a calculation of Typical_Availability. In general, this is an evaluation of the percent of time a platform is generally up and available. It is derived by accessing Scheduled_Hours at field 49 as shown in Table 1. From the scheduled hours input, Downtime is subtracted. Downtime is accessed from field 50 as described in conjunction with Table 1. That valuation then is divided by the noted Scheduled_Hours. Next, as represented at arrow 148 and block 150, the program looks up a factor based upon an organization user input as represented at field 95 in Table 2. Fact of outage is the percent impact to the business or organization of an unexpected outage. Accordingly, the user or organization elects a numerically identified level as set forth in field 47 in Table 1. These levels represent a hierarchal succession of consequences or impact for each one of these levels noted percent impact to the organization business is assigned. In this regard, looking to field 47 in Table 1, at a level 1 the staff will do something else that is equally productive and the outage impact is assigned as 10%. At the second level of the hierarchy, the staff will do something else moderately productive and the corresponding outage impact is assigned as 20%. At the third level, the staff will do something else that is far less productive and the outage impact is assigned as 40%. At level 4, the staff will perform the same task manually and the outage impact is assigned as 60%. At level 5, the staff can do nothing and productivity is severely impacted, an outage impact at this level being assigned as 80%. At the highest level 6, it is considered a major exercise to restore the systems when they return and the outage impact is assigned as 100%.

The program then continues as represented at arrow 152 and block 154 to calculate Unavailability. As described at row 96 in Table 2, Unavailability is the liability or lost opportunity to the business because applications are down. It is derived as the Total_Application_Value as derived at block 146 times the expression (1 minus Typical_Availability) (block 146) times the Impact_of_Outage. Impact_of_Outage is the percentage impact as derived in conjunction with block 150.

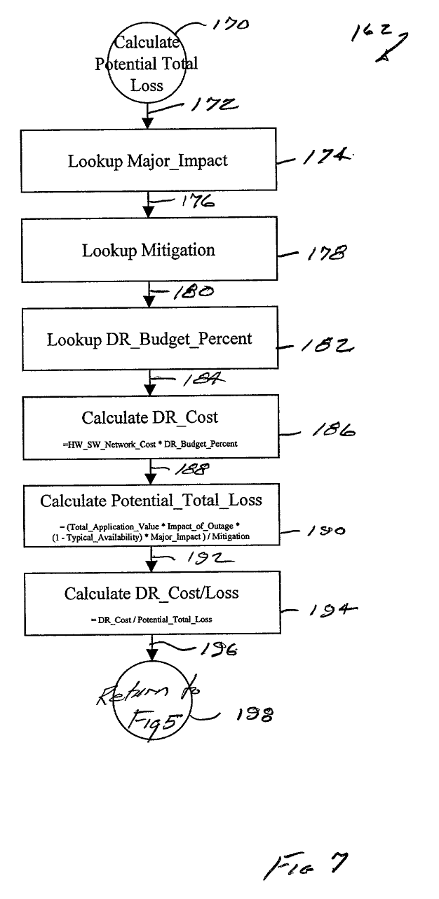

Then, as represented at arrow 156 and node 158, the program returns to FIG. 5. Looking to FIG. 5, arrow 160 is seen to extend from block 140 to block 162 which provides for a calculation of Potential_Total_Loss. This component of the program considers the aspect of a major loss of an IT function and is described at an enhanced level of detail in connection with FIG. 7. Referring to FIG. 7, this component of the program is seen to be entered at node 170 and arrow 172 extending to block 174. Block 174 describes the calling for a look-up of Major_Impact. Major Impact as described at row 97 of Table 2 is concerned with Daily Impact which is elected by the user or organization as set forth at field 48 in Table 1. As before, a numerically designated hierarchal sequence of daily impact levels is provided to the user or organization for election. Looking to field 48, level 1 is elected when a department is impacted but business continues. A level 2 is elected where a major dislocation to internal departments occurs. Level 3 is elected where there would occur a significant impact on revenue. Level 4 is elected where there would occur a severe impact on business revenue. Finally, level 5 is elected where a business disaster would occur of a level, for example, that the user would read about in the Wall Street Journal and company goodwill is severely impaired. As established at Table 2, row 97, a daily impact level one creates a factor of 2.5; a daily impact level two creates a factor of 4; a daily impact level of three creates a factor of 6; a daily impact level four creates a factor of 7; and a daily impact level of 5 creates a major impact level of 9.5.

Major_impact having been looked up, then as represented at arrow 176 and block 178, Mitigation is looked up. As described at row 98 in Table 2, Mitigation is concerned with disaster recovery which is established, again by election of the user or organization, in conjunction with field 51 as set forth in Table 1. Looking to field 51 in Table 1, a sequence of numerically designated hierarchical levels is revealed. At level one, a daily, full backup will be provided. At level two, a daily incremental backup and weekly, full backup will be provided. At level three, a weekly, full backup is provided with no incremental backup. At level four, an infrequent backup evidencing a mixture of approaches is provided and at level five “Other” is assigned. Returning to row 98 of Table 2, it may be seen that a factor of 1 is assigned to level one; a factor of 1.5 is assigned to level 2; a factor of 2 is assigned to level 3; a factor of 3 is assigned to level 4; and a factor of 5 is assigned to level 5. Should a next hierarchical level designated as 6 be incorporated in the methodology, it would be assigned a factor of 5.

Next, as represented at arrow 180 and block 182 the program looks up disaster recovery budget percent (DR_Budget_Percent) which, as indicated at row 99 of Table 2 is a representation of the typical cost of hardware, software and networking of disaster recovery methodologies and, as before, is evolved as a sequence of percentages corresponding with the above noted DR Method. Accordingly, for the five-hierarchical levels of field 51, level 1 is assigned 3%; level 2 is assigned 7%; level 3 is assigned 18%; level 4 is assigned 26%; and level 5 is assigned 60%. Should still another hierarchical level 6 be incorporated, it would be assigned 100%.

The program then continues as represented at arrow 184 and block 186 to provide for the calculation of disaster recovery cost (DR_Cost). As described at row 100 of Table 2, DR_Cost is the cost of disaster recovery precautions and is derived as the product of HW_SW_Network_Cost (FIG. 4, block 102) times DR_Budget_Percent as discussed in connection with bock 182.

The program then continues as represented at arrow 188 and block 190 which is concerned with the calculation of Potential_Total_Loss as described in conjunction with row 101 of Table 2. This represents the cost of potential catastrophic failure for application or each platform and is computed in accordance with the expression: (Total_Application_Value times Impact_of_Outage times (1 Minus Typical_Availability) times Major_Impact) divided by Mitigation. Total_Application_Value has been described at block 136 in FIG. 5. Impact_of_Outage has been described in conjunction with block 150 in FIG. 6. One minus Typical_Availability has been described in conjunction with block 154 in FIG. 6. Major_Impact has been described in conjunction with block 174. Mitigation has been described in conjunction with block 178.

The program then continues as represented at arrow 192 and block 194 which provides for calculating faster recovery costs to potential total loss ratio as described at row 102 in Table 2, the ratio providing the relative cost of disaster recovery compared to the cost incurred. (DR_Cost/Potential_Total_Loss). Potential Total Loss is derived as represented at row 101 of Table 2 as (Total Application Value times Impact of Outage times (1 minus Typical Availability) times Major Impact) divided by Mitigation. Total Application Value has been described in conjunction with block 136 in FIG. 5. Impact of Outage has been described in conjunction with block 150 of FIG. 6. (One minus typical availability) has been described in conjunction with block 154, FIG. 6. Major Impact has been described in conjunction with block 174; and Mitigation has been described in conjunction with block 178.

The program then returns to FIG. 5 as represented at arrow 196 and node 198. Looking to FIG. 5, arrow 200 is seen to extend from block 162 to block 202 which provides for the calculation of Inflexibility. As described at row 104 of Table 2, Inflexibility is concerned with the impact of maintenance and changes on the value of each application or each platform. In effect, the term concerns how much it costs an organization in lost business opportunities because it was maintaining a system it already had, as described at row 104 of Table 2, it is the product of base Inflexibility times (Sum of Total_Application_Value/Sum of Total_IT_Budget). As described at row 103 of Table 2, base Inflexibility is calculated as Maint_Dev times Average_Salary_Maint_Dev as described in conjunction with block 98 of FIG. 4. Average_Salary_Maint_Dev is accessed from field 28 as shown in Table 1. The application values which are summed are described in FIG. 5 in connection with block 136; and the sum of the Total IT Budget is the applications summed IT budget described in conjunction with block 102 of FIG. 4.

The program then continues as represented at arrow 204 and block 206 to calculate the Net_Application_Value. Essentially, this net application value is developed by subtracting all expenses and liabilities from the total application value and further minus the IT budget. The value represents the worth of a given application and may be summed for a portfolio of applications. As is set forth at row 105 of Table 2, the net application value is the total application value, as described in conjunction with block 136, minus Total_IT_Budget, as described in connection with block 102 of FIG. 4; minus Internal_User_Cost as has been described at block 22 of FIG. 2; minus Potential_Total_Loss, as described in conjunction with block 190 of FIG. 7; minus Inflexibility as described in conjunction with block 202.

As represented at arrow 208 and node at 210, the program then returns to FIG. 1 wherein arrow 212 is seen directed to block 214 providing for the allocation of results, i.e., the development of reports for senior management. There is substantial flexibility in this regard, however, application value and its components are calculated first on an application basis, then summarized over an entire portfolio. Based upon organization or user preferences, these results can be split into a number of views to focus on specific business issues. For example, results can be allocated to specific internal user departments based on the population that is using specific applications. Results can be allocated to operating environments or platforms based on the technology underlying each application. Results can be split by company product or external constituency based on key, consumer-supply metrics. This metric and data driven approach allows for flexibility in reporting, delivering additional analysis on request from the results of carrying out the methodology. Additionally, as represented at arrow 216 and symbol 218 the results of the methodology can be submitted to database storage. Such storage can be employed to, in effect, compile a history of the operation of IT infrastructures. That information over time can be utilized for trending and a variety of forms of analysis as well as the evolution of modeling. For immediate purposes, as noted above, and as represented at arrow 220 and symbol 222, analytical reports can be prepared for each exercise of the methodology before presentation to senior management, ie., the user.

Inasmuch as such analytical reporting may take a variety of forms depending upon the desires of the user, a compilation of model reports is annexed hereto as an appendix.

Since certain changes may be made in the above-described method without departing from the scope of the invention herein involved, it is intended that all matter contained in the description thereof or shown in the accompanying drawings shall be interpreted as illustrative and not in a limiting sense.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

1. The method for determining the net value of at least one information technology application specific to an organization having a system with a computer-based infrastructure, users thereof, support functions, and a total IT budget, comprising the steps of:
determining a user value contribution of said application as an internal user cost and an external user cost;
determining a breakout of said total IT budget by assigning a number of select cost categories therefrom and for each such cost category determining a total budget value;
determining a breakout of staffing costs and resources by deriving a select number of staff function costs and combining said function designated costs to provide an IT budget corresponding with said total IT budget;
determining a total value for said application by deriving an uplift factor for said application, determining a base application value with respect to said internal user cost and then deriving the product of said base application value and said uplift factor and combining said product with said external user cost;
determining an unavailability value for said application;
determining a potential total loss value for said application;
determining an inflexibility value for said application; and
determining said net value as said total value for said application less said total IT budget, said internal user cost, said potential total loss, and said inflexibility.

2. The method of claim 1 including the step of:
preparing an analysis of said at least one application including at least one of the group comprising; said net value, said breakout of said total IT budget, said breakout of staffing costs and resources, said unavailability value, said potential total loss value, and said inflexibility value.

3. The method of claim 1 in which said step of determining a user value contribution of said application derives said internal user cost as the number of internal users of said application multiplied by the internal user salary, in turn, multiplied by the percent of internal active concurrent users.

4. The method of claim 1 in which said step of determining a user value contribution of said application derives said external user cost as the number of external users of said application multiplied by the external user salary, in turn, multiplied by the percent of external active concurrent users.

5. The method of claim 1 in which said step of determining a breakout of said information technology budget by assigning a number of select categories therefrom, assigns at least one said select category from the group consisting of; fully loaded staff cost, hardware cost, software cost, network cost, consulting cost, and other.

6. The method of claim 1 in which said step of determining a breakout of said information technology budget includes the steps of:
determining internal budget splits for each said select category; and
determining budget splits for each said select category.

7. The method of claim 6 in which said step of determining a user value contribution of said application determines a said total budget value for each said cost by summing said internal budget splits for each said category with respective said budget splits corresponding therewith.

8. The method of claim 1 in which said step of determining a breakout of staffing costs and resources derives said select number of staff function costs from the function group comprising:
senior manager staff, new development staff, maintenance development staff, operations staff, technical staff, and other staff.

9. The method of claim 1 in which said step of determining a breakout of staffing costs and resources includes the step of deriving the gross cost of internal staff for each said function of said select number of staff function costs.

10. The method of claim 9 in which said step of determining a breakout of staffing costs and resources includes the step of deriving the gross cost of staff for each said function of said select number of staff function costs.

11. The method of claim 10 in which said step of determining a breakout of staffing costs and resources includes the steps of:
summing the derived said gross cost of internal staff for each said function to derive a summarized internal staff gross cost; and
summing the derived said gross cost of staff for each said function to derive a summarized staff gross cost.

12. The method of claim 11 in which said step of determining a breakout of staffing costs and resources includes the steps of:
determining the percents by cost for each said gross cost of internal staff for each said function by dividing each corresponding internal staff gross cost by said summarized internal staff gross cost; and
determining the percents by cost for each said gross cost of staff for each said function by dividing each corresponding gross cost by said summarized staff gross cost.

13. The method of claim 12 in which said step of determining a breakout of staffing costs and resources includes the steps of:
determining the fully loaded cost of said internal and staff;
determining a normalized value for each said gross cost of internal staff for each said function to provide normalized internal staff gross costs by multiplying such gross cost by the corresponding said percents by cost for internal staff; and
determining a normalized value for each said gross cost of staff for each said function to provide normalized staff gross costs by multiplying said gross cost by the corresponding said percents by cost for staff.

14. The method of claim 13 in which said step of determining a breakout of staffing costs and resources includes the steps of:
summing said normalized internal staff gross costs with said normalized staff gross costs for each said function to derive corresponding staff gross costs for each said function.
